(19) United States
(12) Patent Application Publication
(10) Pub. No.: US 2021/0017047 A1
(43) Pub. Date: Jan. 21, 2021

(54) Metal-Loaded Basic Immobilized Amine Sorbents For The Removal Of Metal Contaminants From Wastewater

(71) Applicant: United States Department of Energy, Washington, DC (US)

(72) Inventors: Brian W. Kail, Pittsburgh, PA (US); McMahan L. Gray, Pittsburgh, PA (US); Walter C. Wilfong, Clinton, PA (US); Qiuming Wang, South Park, PA (US); Fan Shi, Pittsburgh, PA (US)

(21) Appl. No.: 16/931,987

(22) Filed: Jul. 17, 2020

Related U.S. Application Data
(60) Provisional application No. 62/875,364, filed on Jul. 17, 2019.

(51) Int. Cl. C02F 1/28; B01J 20/26

(52) U.S. Cl. CPC C02F 1/288; B01J 20/267; C02F 2101/22; C02F 1/281; C02F 1/285

(57) ABSTRACT

One or more embodiments relate to a method of separating a target contaminant from an aqueous source by contacting a polyamine network-based sorbent with the aqueous source; and capturing and separating the target contaminant from the aqueous source.

### CROSS-REFERENCE TO RELEATED APPLICATION

This application claims priority from U.S. Provisional Application Ser. No. 62/875,364 filed Jul. 17, 2019, the complete subject matter of which is incorporated herein by reference in its entirety.

### STATEMENT REGARDING FEDERAL, SPONSORED RESEARCH OR DEVELOPMENT

The United States Government has rights in this invention pursuant to an employer/employee relationship between the inventors and the U.S. Department of Energy, operators of the National Energy Technology Laboratory (NETL), and site-support contractors at NETL.

### FIELD OF THE INVENTION

One or more embodiments consistent with the present disclosure relate to compositions and methods for heavy metal capture, specifically the toxic oxoanionic forms, from a variety of sources that exceeds the existing amine-sorbent ability by greater than 50% as evidenced herein, and includes materials, methods of preparation, and methods for using the compounds described in various applications.

### BACKGROUND

Published in 1976, the US Resource Conservation and Recovery Act (RCRA) endowed the US Environmental Protection Agency with the authority to establish and enforce regulatory policies and toxicity limits with respect to Arsenic (As), Cadmium (Cd), Chromium (Cr), Lead (Pb), Mercury (Hg), Selenium (Se), and other metals. Many of these metals present a distinct challenge for capture as they are most commonly present in the polyatomic oxyanion form. For example, water soluble Se (in the VI and IV oxidation states) are expressed as the selenate (SeO₄²⁻) and selenite (SeO₃²⁻) oxyanions, and chrome, in its most water-soluble form exists as the chromate oxyanion, CrO₄²⁻. Sources for most of these contaminant metals include flue gas desulfurization (FGD) wastewater streams. These streams result from the treatment of fossil fuel-derived, post-combustion flue gas with aqueous-based technologies. The well-known and widespread contamination of RCRA metals in our drinking water and other terrestrial water sources, either through natural processes or resulting from human activity, demands their remediation.

Equally or more toxic than RCRA metals, radioactive pollutants in aqueous form raise concerns about exposure levels in the nearby communities because it is feared that these fission products could make their way into the food chain causing high-level biological damage. For example, Tc-99 at a federal storage facility located at Hanford, Wash. (Hanford Site) is one of the top concerning radioactive ions due to its high environmental mobility under oxidizing states in addition to a long half-life (2.1×105 yrs). The Hanford Site has a total of 53 million gallons of waste in 177 tanks, where radioactive Tc-99 anion is among hundreds of contaminants in the tank waste. Sixty-seven tanks have leaked or were suspected to have leaked 1 million gallons or more of liquids into the underlying sediment. However, it is a challenging task to selectively recover Tc from water sources because of the overall low concentration of the Tc contained compounds. The waste is highly caustic and may produce hydrogen. Removal of trace Tc-99 from tank waste at the Hanford Site presents significant challenges to all researchers and engineers. Waste water generated from FGD were treated using the NETL amine based sorbents. During the treatment, a multitude of heavy metals (such as Cr, As, Cd, Hg, Sr, Se, Re, etc.) at very low concentrations were captured. It was determined that many of the heavy metals captured from FGD water have radioactive isotopes (76As, 90Sr, and 79Se) which are hazardous fission products because of the high yield and/or relatively long half-life (See FIG. 6 and FIG. 8). Re is not radioactive waste, however, the non-radioactive perrhenate ion (ReO₄, Re) was used to mimic the radioactive (TcO_{4,} Tc-99 ion) because the two ions are sufficiently similar to provide a basis for comparison.

Embodiments of the present disclosure provide a series of amine based sorbents for the remediation of coal-associated waste streams such as FGD, acid mine drainage (AMD) effluent streams and hydraulic fracturing water (Frac Water) and the like, with the specific aim of capturing rare earth elements (REE) and heavy metals from these and other sources. One or more embodiments of the present invention relates to an amine-based sorbent material that has increased affinity towards heavy metal capture, specifically the toxic oxoanionic forms, from a variety of sources that exceeds the existing amine-sorbent ability by greater than 50% as provided below.

Accordingly, it is an object of this disclosure to provide cross-linked polyamine-based polymer networks that can also be functionalized onto cheap and stable silica supports. This could facilitate rapid commercialization of the amine-based sorbents as a practical solution for radioactive ions (such as 99Tc, 1291, 76As, 90Sr, and 79Se) immobilization.

These and other objects, aspects, and advantages of the present disclosure will become better understood with reference to the accompanying description and claims.

### SUMMARY

One or more embodiments relates to the utilization of a metal-chelated polyamine that is chemically tethered to a solid silica support via an epoxysilane crosslinker. These sorbents are used for the capture of heavy metals from a variety of aqueous sources. The covalent and H₂O-stable sorbents resist leaching by H₂O in an aqueous stream containing heavy oxyanion-based (and other) metals, with stability over a pH range of 5-14. The cationic heavy metals are captured by the co-existing amine (—NH₂, —NH, —N) from the polymeric network while the oxoanionic metal species bond to the metal loaded sites.

The combination of different polyamines and monomer cross-linkers covalently loaded with non-toxic metals effectively captured highly toxic As, Se, Cr, Cd, Pb, Hg metals, and radioactive Tc surrogate metal Re (present in high concentrations) within a low-cost material. This stable metal loaded, immobilized amine sorbent captured ˜100% of target metals from solutions at concentrations of 25 ppm (100 ppm for Re) as single components and 75 ppm total as multicomponent mixtures. The high affinity of these SiO₂ supported metal loaded polyamine sorbents towards polyatomic oxoanionic and cationic toxic heavy metals confirms the ability of these sorbents to exceed the efficiency of related supported polyamine sorbents in the removal of toxic metals from aqueous sources.

One or more embodiments relate to a method of separating a target contaminant from an aqueous source. The method includes contacting a polyamine network-based sorbent with the aqueous source; and capturing and separating the target contaminant from the aqueous source.

Yet one or more other embodiments relate to a method of separating a target contaminant containing at least one target contaminant heavy metal from an aqueous source. The method includes contacting a polyamine network-based sorbent comprising an oxyanion-capturing cationic metal chelated to a polyamine chemically tethered to a solid silica support via an epoxysilane crosslinker with the aqueous source; and capturing and separating the target contaminant heavy metal from the aqueous source.

Still other embodiments relate to a method of forming a polyamine network-based sorbent used in separating a target contaminant from an aqueous source. The method includes chemically tethering a polyamine to a solid silica support using an epoxysilane crosslinker; and chelating an oxyanion-capturing cationic metal to the polyamine. An additional embodiment involves pre-chelating the oxyanion-capturing cationic metal to the polyamine prior to tethering to a solid silica support using an epoxysilane crosslinker.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 depicts a set-up for assessing sorbent stability via washing used for testing absorption of dissolved metal ions from flowing liquid environments;

FIG. 2 depicts a graph illustrating leach testing results for a 0.3% (w/w) copper loaded sorbent;

FIG. 3 depicts a graph illustrating single wash testing of 14-36A (0.15 wt % Cu) and 14-36A (0.3% (w/w) sorbents with identical organic loadings 14-36A (0.15% w/w Cu) and 14-36B (0.3% w/w Cu);

FIG. 4 depicts a graph illustrating flowing selenium and arsenic uptake comparison of BIAS sorbents versus metal loaded variant BIAS sorbents at 0.5 g loadings;

FIG. 5A depicts a graph illustrating flowing uptake of a 3 component mixture at 25 ppm each with sorbent 14-36A (0.15% w/w Cu) and 14-36B (0.3% w/w Cu), while FIG. 5B depicts a graph illustrating digested sorbent metal content before and after 3 component uptakes where -S represents the spent sorbent and F-represents the fresh sorbent;

FIG. 6 depicts a graph illustrating a comparison of BIAS sorbent 181 D to copper-loaded BIAS sorbent 14-36A (0.15%) and 14-368 (0.3%) for uptake efficiency from an authentic flue gas desulfurization water;

FIG. 7 depicts a graph illustrating hybrid-hydrogel sorbents in flow uptake testing with copper and iron loading relative to un-doped materials in uptake testing of toxic heavy metals;

FIG. 8A depicts a graph illustrating as-is (M-0.43) and Fe-loaded (M-0.43+Fe) monolith-based sorbents in flow uptake testing of ideal, 25 ppm Cr and Se solutions (top) while FIG. 8B illustrates authentic flue gas desulfurization water (bottom);

FIG. 9 depicts a graph illustrating sorbents in batch uptake testing with copper and iron loading relative to un-doped materials in uptake testing of 100 ppm Re;

FIG. 10 depicts a graph illustrating leach testing results for a 0.3% (w/w) copper loaded sorbent;

FIG. 11 depicts constituents for synthesizing the metal-loaded polyamine compositions for immobilization on silica;

FIG. 12 depicts a schematic illustrating a method for the synthesis of a metal loaded sorbent; and

FIG. 13 depicts a flowchart illustrating a method of separating a target contaminant containing at least one target contaminant heavy metal from an aqueous source.

### DETAILED DESCRIPTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

One or more embodiments relates to sorbents comprising a metal-chelated polyamine that is chemically tethered to a solid silica support via an epoxysilane crosslinker. These sorbents are used for the capture of heavy metals from a variety of aqueous sources. The covalent and H₂O-stable sorbents resist leaching by H₂O in an aqueous stream containing heavy oxyanion-based (and other) metals, with stability over a pH range of 5-14. The cationic heavy metals are captured by the co-existing amine (—NH₂, —NH, —N) from the polymeric network while the oxoanionic metal species bond to the metal loaded sites.

An array of amine based sorbents with SiO₂ as a solid substrate were synthesized by first mixing amines, chemical crosslinkers, and SiO₂ particles in a flask using methanol or methanol/water as the solvent. Solvent was then evaporated and the silica-crosslinker-amine reaction was carried-out under vacuum between 70° C. and 90° C., producing a dry granular base sorbent. These base sorbents were then washed with copious amounts of 18 MΩ water to remove small amounts of unbound amines. A typical preparation took between 1 and 3 hrs, depending on the base sorbent formulation (non-metal-chelated). The crosslinkers used in the preparation were associated with different types of sorbents: (i) aminosilanes, such as 3-aminopropyltrimethoxysilane (APTMS), N-(3-trimethoxysilyl) propyl)ethylenediamine (TMPED), and N-(3-Trimethoxysilylpropyl)diethylenetriamine (TMPDET) plus epoxysilane, 2-(3,4-epoxycyclohexyl)ethyltrimethoxysilane (ES) for layer-based BIAS sorbent, (ii) tri-epoxide monomer, N-N-diglycidyl-4-glycidyloxyaniline (E3) for monolith based sorbent, and (iii) acrylamide and N,N′-Methylenebis(acrylamide) (MBAA) monomers combined with ammonium persulfate (APS) and N,N,N′,N′-Tetramethylethylenediamine (TMEDA) free radical polymerization initiators for hydrogel-based sorbents. The amines consist of polyamines such as polyethylenimine (PEI), triethylenetetramine (TETA), diethylenetriamine (DETA),and ethyleneimine.

Metal loaded sorbents were prepared from the base sorbents by the insipient wetness method, reacting methanolic solutions of the Cu(II), as CuCl₂, or Fe (III) as FeCl₃, with the amine sorbents in the flask at 80° C. under vacuum. The resulting products were heat treated in a drying oven at 70° C. from 4 hours to overnight. Sorbent samples were subjected to digestion and ICP-OES analysis for total metal content.

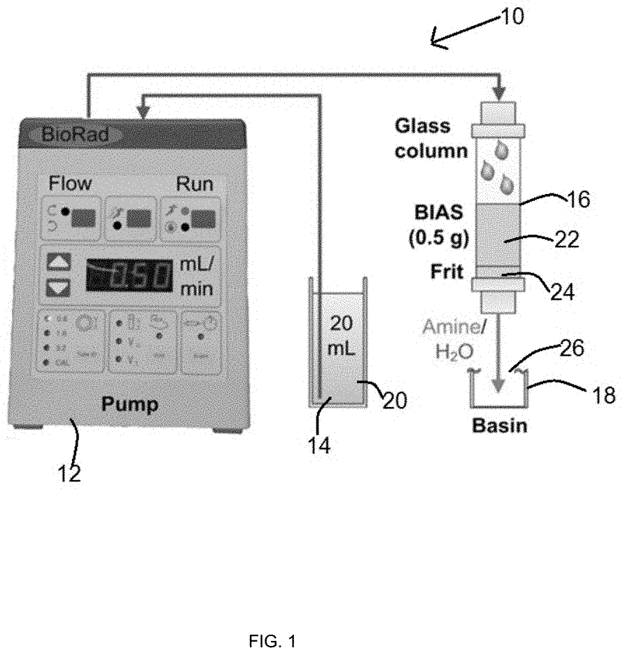

Initial screening of the sorbents for their stability in a flowing liquid environment was accomplished using an accelerated H₂O method. FIG. 1 depicts a set-up 10, generally designed, for assessing sorbent stability via washing used for testing absorption of dissolved metal ions from flowing liquid environments. FIG. 1 illustrates pump 12 in fluid communication with reservoir 14 containing H₂O 20 and glass column 16 containing sorbent 22 and frit 24. In turn glass column 16 is in fluid communication with basin 18 containing amine, H₂0 or amine/H₂0 26. The accelerated H₂O method performed using set-up 10 involves contacting 0.5 g of sorbent with 0.5 mL/min of flowing H₂O in glass column 16 for 20 min. In one embodiment the 0.5 mL/min of flowing H₂O is controlled by pump 12 which pumps H₂O from reservoir 14 to glass column 16. To assess longer term stability, an identical amount of sorbent was treated with successive amounts of water, in 20 ml increments with each fraction analyzed for copper content. In addition, the amount of copper released was compared to the total loaded copper content of the un-washed sorbent. Furthermore, the washed sorbent materials were subjected to digestion and ICP analysis for total copper content for mass balance comparison and a more accurate assessment of sorbent stability. Additional stability testing was performed at pH 2.5, pH 5.0 and pH 8.5 to gain an understanding of the leach resistance under diverse conditions.

Metal loaded sorbent uptake testing was conducted using one of two methods. The first method, a batch uptake test method, includes agitating 0.04 g to 0.5 g of sorbent in 20 mL of 25-1000 ppm ion solution for 40 min at room temperature. The resulting liquid was filtered using a 0.2 μm PVDF filter to remove solid particles. The second method, a flow uptake test method, includes the absorption test accomplished using a set-up 10 similar to that discussed above as the H₂O leach testing for sorbent stability, where the sorbent was directly contacted for 40 min by a 0.5 mL/min flow of metal solution at 25 to 100 ppm. Concentrations of target ions in all solutions were measured using a Nexion 3000 ICP-MS (Perkin Elmer). Data was collected in kinetic energy discrimination (KEO) mode using 2-4 ml/min He as the collision gas. Indium was used as an internal standard. A calibration curve was constructed, relating known concentrations of different ions in DI H₂O to the ICP-MS response intensity. This curve was used to calculate the ions concentration in our solutions.

Radioactive ions are expensive and generate environmental hazardous wastes, so non-radioactive Re surrogates were used to study the sorbents affinity for the Tc99 ion were used. The capture of Re by stable amine sorbents and metal loaded sorbents was conducted using two methods. In the first method, a batch test method, 0.5 g of sorbent was agitated in 20 mL of 4-100 ppm ion solution for 40 min at room temperature. The resulting liquid was filtered by a 0.2 μm PVDF filter (Whatman) to remove solid particles. In the second method, a flow test method, the absorption test was accomplished using set-up 10 similar to that discussed above for the accelerated H₂O, where the sorbent was directly contacted for 40 min by a 0.5 mL/min flow of simulated Hanford Site waste solution. Concentrations of interested ions in all solutions were measured using a Nexion 300D ICP-MS (Perkin Elmer). Data were collected in kinetic energy discrimination (KED) mode using 2-4 ml/min He as the collision gas. Indium was used as an internal standard. A calibration curve was constructed, relating known concentrations of different ions in DI H₂O to the ICP-MS response intensity. This curve was used to calculate the ions concentration in our solutions.

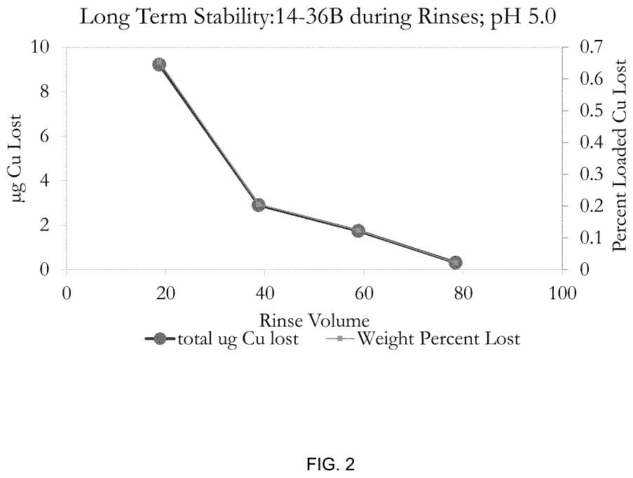

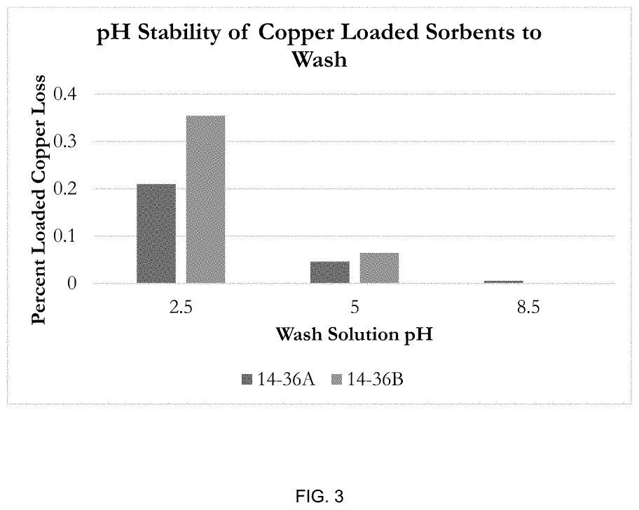

Sorbents were prepared with target loadings of −0.15% and 0.3% (w/w) metal by the insipient wetness preparation with aid of a rotary-evaporator set at 80° C., and a vessel pressure reduction from atmospheric pressure (1000 mbar) to ˜20 mbar over a 1-hour period. Metal sorbents were prepared from the methanolic metal halide solution and amine/crosslinker impregnated sorbent formula. However, initial sorbents were prepared by flowing 100 ppm aqueous solutions of either FeCl₃ or CuCl₂ over the sorbent, as described in the previous metal uptake testing section. Once prepared, sorbents were dried at 70° C. overnight and tested for metal leaching by continuous flow (See the graph in FIG. 2) or single washes (See the graph in FIG. 3).

Initial H₂O stability testing of the metal-amine species was performed at the natural pH of 5.5 under continuous flow conditions. Results showed that most unbound copper was removed in the first 20 ml of wash water. Further testing of the sorbent stability at pH values of 2.5 and 8.5 was performed to assess the leach resistance of the amine-Cu species under acidic and basic conditions, as shown in FIG. 3. Shown here is the 0.3% (w/w) copper loaded sorbent, which would be expected to have the greatest amount of leachable copper.

As expected, leaching was reduced as the pH of the wash solution was increased, with excellent stability from pH 5 (0.061% w/w initial copper loss) to pH 8.5 (0.01% w/w initial copper loss).

However, copper losses at pH 2.5 were also found to be acceptable at 0.2% to 0.35% w/w loss of total loaded copper.

Heavy metal uptake was compared between the state-of-the-art immobilized amine-silica sorbents BS53A, BS181 D and BS57A (non-metal-loaded) described in a related patent and their iron and copper loaded analogues, BS53ACu and BS53AFe.

These tests demonstrated a ˜55%-˜60% increase in the uptake of selenium, as sodium selenate, and arsenic, as dibasic sodium arsenate, relative to the non-metal loaded counterpart.

A similar test, under identical conditions as those for Se but using arsenic, as sodium arsenate, supported the body of work and indicates ˜50-˜60% increase in uptake relative to the related non-metal loaded BIAS counterpart.

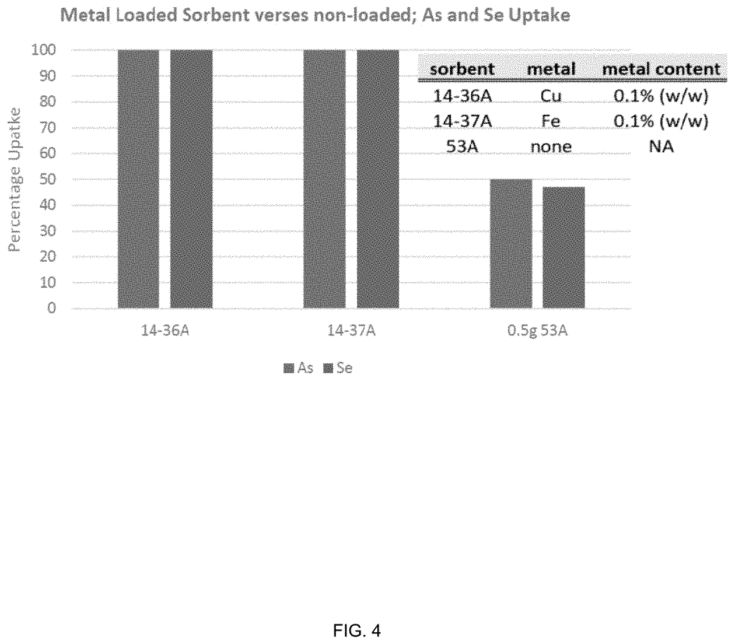

FIG. 4 depicts a graph illustrating flowing selenium and arsenic uptake comparison of BIAS sorbents versus metal loaded variant BIAS sorbents at 0.5 g loadings. Table 1 illustrates the different sorbents, metals and metal content of FIG. 4.

TABLE 1

| Sorbent | Metal | Metal Content |
|---|---|---|
| 14-36A | Cu | 0.1%(w/w) |
| 14-37A | Fe | 0.1%(w/w) |
| 53A | None | NA |

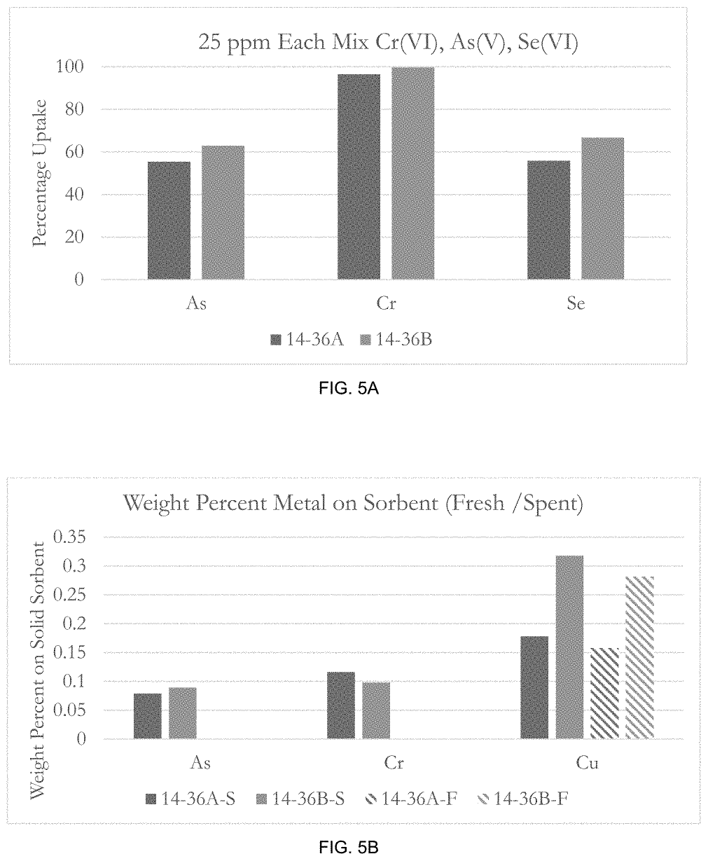

When a three-component mixture containing 25 ppm each of As, Cr, and Se was tested, the metal loaded sorbents either were equal to or exceeded the BIAS variants single component uptake efficiency (See FIGS. 5A and 5B).

Furthermore, total digestion of the sorbent, before and post treatment in this test confirmed both the stability of the active copper center with ˜0.03% (w/w) loss from both a 0.15% and 0.3% (w/w) initial Cu loading after metal uptake testing. It is also important to note that the 0.15% (w/w) Cu-loaded sorbent had similar final capture amounts of As and Cr˜0.19% (w/w) as those for the 0.3% (w/w) Cu-loaded sorbent indicating that seemingly small metal loadings dramatically modulated the affinity of the sorbents towards the polyanionic metal species.

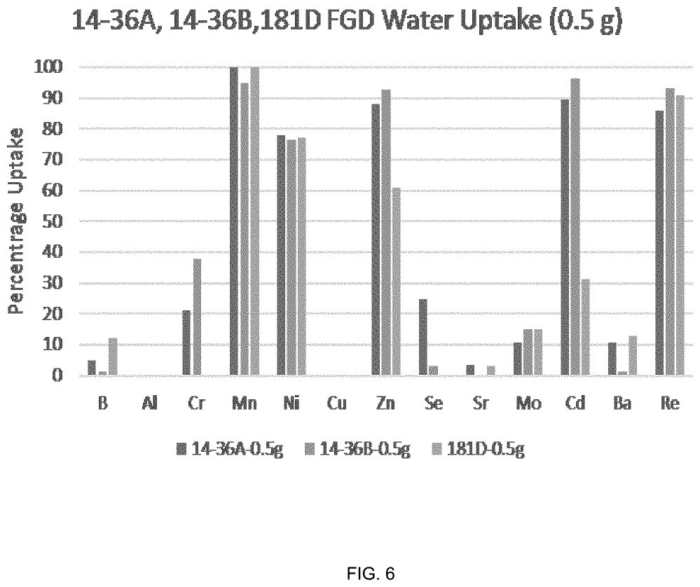

A final measure of the usefulness of the type of sorbent may be found in FIG. 6, with the results of authentic flue gas desulfurization water sample testing.

In this test, the usefulness of the copper loaded sorbent was evidenced by ˜70% increase in cadmium uptake, 30% increase in selenium uptake and 40% increase in chromium uptake, relative to a comparable BIAS sorbent with no incorporated copper.

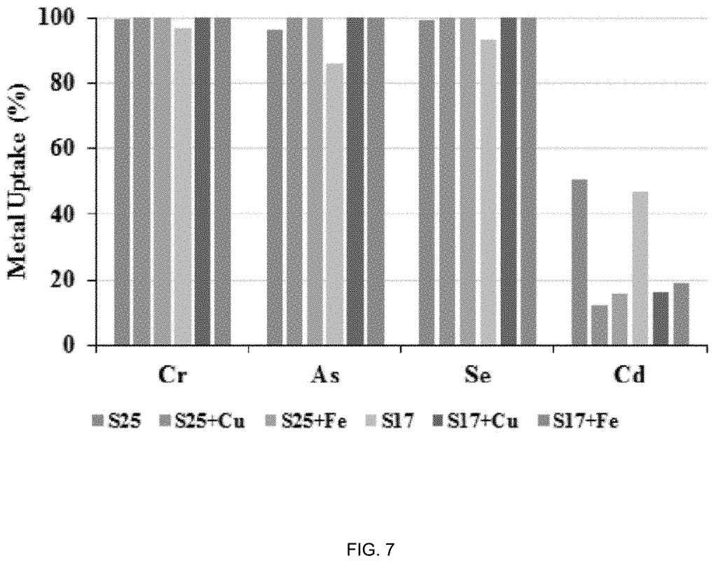

Related sorbents of the hybrid hydrogel class of immobilized amine sorbents, with metal loading and achieved equally compelling results were also prepared (See FIG. 7).

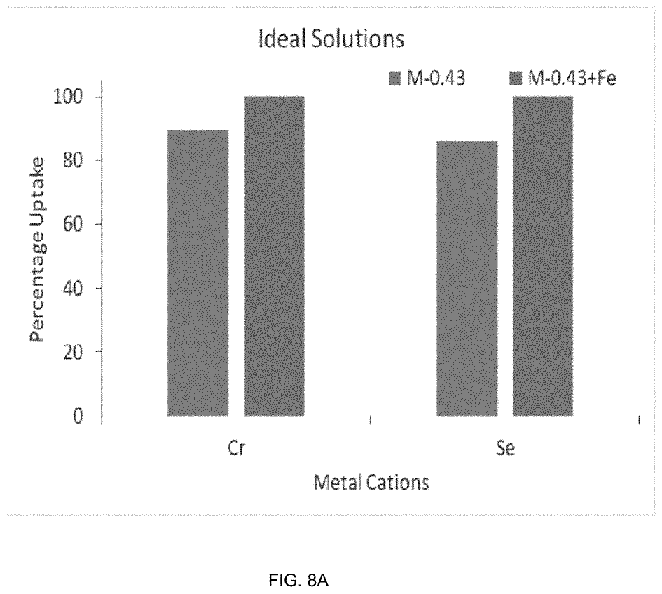

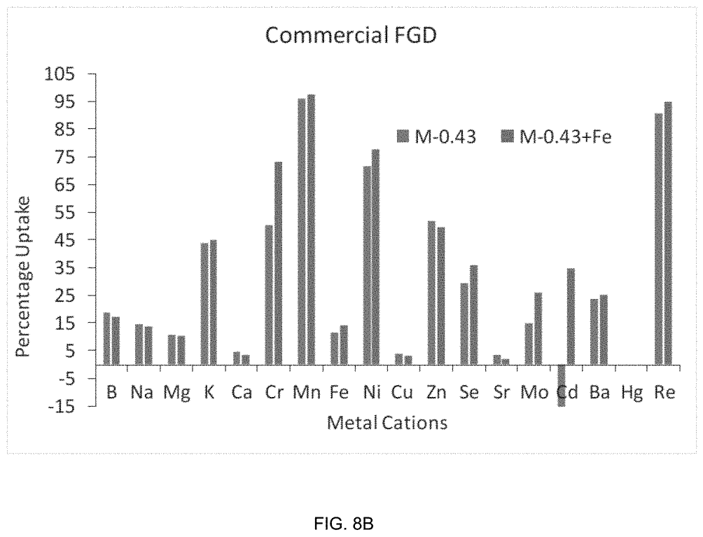

A monoliths based sorbent, M-0.43, containing 28 wt % PEI and 12 wt % E3 on SiO₂, illustrated in FIGS. 8A and 8B, displayed improved metal absorption upon loading with Fe to create the M-0.43+Fe material. These improvements were observed for Cr and Se in both the ideal solution (FIG. 8A) and real FGD water applications (FIG. 8B).

Non-radioactive Re is a surrogate of radioactive Tc and is used in testing. Their oxidation states have similar chemical and physical properties. For example, they have the same charge per volume and the radius of their oxidation state, are very close in water. Given the difficulty in dealing with radioactive Tc in a typical laboratory setup, many research labs use ReO⁻ to mimic TcO⁻. While the two ions are not identical, they are sufficiently similar to provide a basis for comparison.

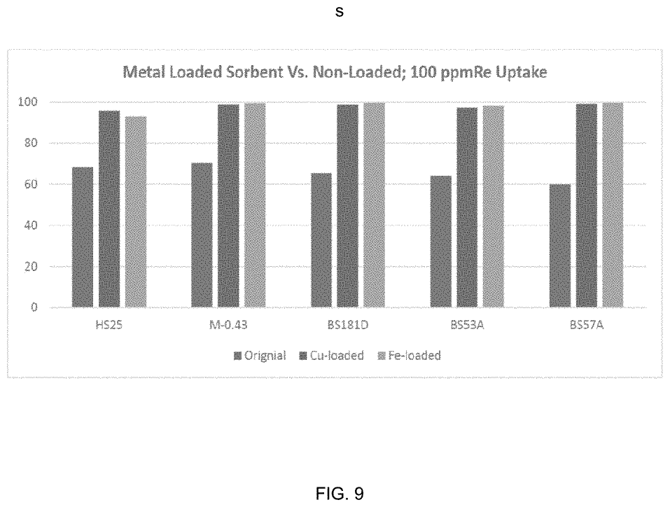

Re uptake was compared between the state-of-the-art immobilized amine-silica sorbents HS 25, M-0.43, BS181 D, BS53A, and BS57A (non-metal-loaded) described in a previous patent and their iron and copper loaded analogues (See FIG. 9). These tests showed ˜30%-40% increase in the uptake of Re, as Potassium Perrhenate, relative to the non-metal loaded counterpart.

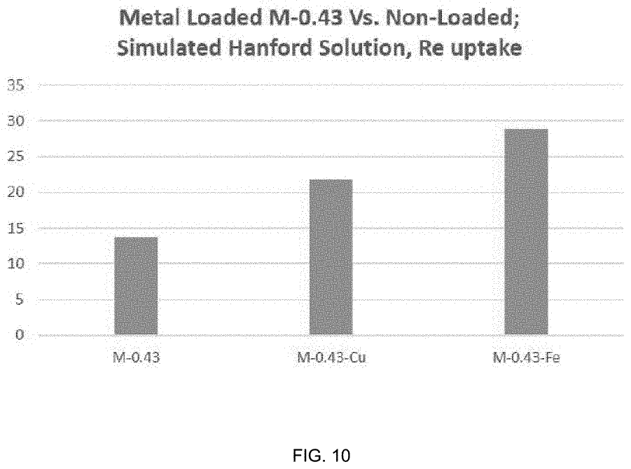

Table 1 depicts the cation composition of a simulated waste solution from the Hanford site. FIG. 10 illustrates the comparison of the absorption of Re from simulated waste solution from the Hanford Site (illustrated in Table 2) using non-metal loaded and Cu metal loaded M-0.43 sorbent. As illustrated, the superiority of the Cu-loaded sorbent was evidenced by ˜8% increase in Re uptake and the Fe-loaded sorbent was evidenced by ˜15% increase in Re uptake, relative to a comparable BIAS sorbent with no incorporated metals.

TABLE 2

| Ion Type | Original Concentration (ppm) |
|---|---|
| B | 186,414 |
| Na | 112510.78 |
| Al | 14608.339 |
| K | 3115.412 |
| Re | 6,373 |

Fouling/Re = 20,000/1, pH-14

Easily prepared immobilized amine sorbents that contain novel combinations of polyamines and metals with monomer cross-linkers immobilized on silica are structurally stable and capture a variety of toxic heavy metals with higher capacity compared to non-metaled sorbents. It has been demonstrated that these sorbents capture As (has radioactive isotope), Cr, Cd and Se (has radioactive isotope), which are found in many coal waste streams and industrial effluents. They are also capable of capturing radioactive Tc surrogate ion Re from simulated Hanford waste solution. These low cost, scale-able, and robust materials show promise for commercial scale processes involving toxic heavy metal species and radioactive metals capture from flowing aqueous streams or stagnant aqueous environments. Also significant is the novel methanolic metal solution-based impregnation. This method may impart added stability to the metal loaded sorbent, relative to aqueous loading, by reducing the de-solvation energy. Further, the lack of an aqueous system eliminates unwanted side reactions between inherently dissolved carbonates and metals (Cu, Fe, etc.) that are targeted for loading onto the sorbent.

Alternative versions of this invention include the following instances. (I) Incorporating different hydroxyl-containing supports, such as SBA 15, MCM-41, zeolite 13X, fumed silica, precipitated silica, silica gel, silica pellets, hydroxylated alumina particles or pellets such as those similar to gibbsite, diaspore or boehmite and iron oxide particles with surface hydroxyl groups. (2) Incorporating different radioactive ion capture species, such as (i) polyamines-diethylenetriamine, triethylenetetramine, tetraethylenepentamine, pentaethylenehexamine, hexaethyleneheptamine, poly(propyleneimine) 1,3-cyclohexanebis(methylamine), 4,4′-Methylenebis(cyclohexylamine), 3,3′-Methylenedianiline, o-phenylenediamine, m-phenylenediamine, p-phenylenediamine, Tris(2-aminoethyl)amine, p-Xylylenediamine, 4-Chloro-o-phenylenediamine, N,N′-Dimethyl-1,3-propanediamine, N,N′-Diphenyl-p-phenylenediamine, N,N′-Diisopropyl-1,3-propanediamine, polyvinyl amine, and (ii) aminoacids-arginine, asparagine, aspartic acid, cysteine, methionine, tryptophan, histidine, lysine, glutamine, glutamic acid, and tyrosine. (3) Incorporating different silane-derived linkers, such as (3-Bromopropyl)trim ethoxysilane, (3-lodopropyl)trimethoxysilane, (3-Merca ptopropyl)tri methoxysilane, (3-Chloropropyl)trimethoxysilane,3-(Trimethoxysilyl)propylmethacrylate, 3-Glycidyloxypropyl)trimethoxysilane, and ethoxy versions of these methoxy-based silanes. (4) Incorporating different epoxide monomers or polymers, such as (i) monoepoxides-I,2-epoxybutane, ethyl glycidyl ether (aliphatic), 3,3-dimethyl-1,2-epoxybutane (sterically hindered), 1,2-epoxy-3-phenoxypropane (aromatic-based, with ether group), (2,3-epoxypropyl)benzene (aromatic-based, boether groups), 4-chlorophenyl glycidyl ether (contains a halogen with epoxide); (ii) diepoxides-1,4-butanediol diglycidyl ether (aliphatic, with ether groups), 1,2,7,8-diepoxyoctane (aliphatic, no ether groups), 1,4-cyclohexanedimethanol diglycidyl ether (aliphatic with cyclohexane group), resorcinol (aromatic-based with ether groups), bisphenol A diglycidyl ether (multiple aromatic groups), poly(Bisphenol A-co-epichlorohydrin), glycidyl end-capped (multiple aromatic groups, polymer), D.E.R 332 (bisphenol A based commercial polymer), EPON 826 (bisphenol A based commercial polymer); (iii) triepoxide-tris(2,3-epoxypropyl) isocyanurate (cyanurate groups), tris(4-hydroxyphenyl)methane triglycidyl ether (aromatic-based, with ether groups), Heloxy 48 (commercial polymer); (iv) tetraepoxide-4,4′-methylenebis(N,N-diglycidylaniline) (aromatic based, with tertiary amine groups), tetraphenylolethane glydidyl ether (aromatic based). (5) Incorporating different acrylic-based bi-vinyl crosslinkers, such as ethylene glycol diacrylate (EGDA), PEG diacrylate (PEGDA), 1,3-Butanediol diacrylate, 1,6-Hexanediol diacrylate (HDODA), Bisphenol A ethoxylate diacrylate, 1,4-Butanediol diacrylate, Glycerol 1,3-diglycerolate diacrylate, Neopentyl glycol diacrylate, Tetra(ethylene glycol) diacrylate (TTEGDA), Poly(propylene glycol) diacrylate, Fluorescein O,O′-diacrylate, Bisphenol F ethoxylate (2 EO/phenol) diacrylate, 1,1,1-trimethylolpropanetriacrylate (TMPTA), and tetraalyloxy ethane (TAOE); (6) Incorporating different initiators such as potassium persulfate, benzoyl peroxide, and 2-Hydroxy-4′-(2-hydroxyethoxy)-2-methylpropiophenone. Metals represented by the first, second and third row transition elements such as V, Co, Fe, Ni, Cu, Mo, Al, Ti, Ru, Rh, Pd, W, Re, Os and Pt.

One or more embodiments describe SiO₂ supported polyamine network based sorbents used for the capture of heavy metals from effluent waters, particularly difficult metallic oxyanions of Cr, As, and Se. The sorbents are simply a dried slurry mixture of SiO₂ particles, polyamine, chemical crosslinker in methanol, where methanol was removed in rota-yap at 80° C. for 1 hr. then cured at 90° C. for 1 hour. Methanolic Cu or Fe solutions where introduced via rota-yap at 80° C. Final product was cured for 2 hours at 80° C. in a drying oven. The product has an OCR of >95%; [OCR=(final organic)/initial organic×100%], and retains chelated metal species at >95%; over pH 2.5 to 8.5. The sorbents (non-optimized) captured >99% As, Se, Cr from 25 ppm pure component solutions. The sorbents (non-optimized) captured >99% Cr and >60% As and Se from 25 ppm each component mixed solution. The sorbents (non-optimized) captured 98% of the Cd, 90% Re, 45% Cr and 25% Se from a Flue Gas Desulfurization (FGD) water sample, exceeding the capability of heavy metal recovery bias sorbents recited in commonly owned co-pending U.S. patent application Ser. No. 15/782,315 (U.S. Pat. No. ______) and Ser. No. 16/176,804 (U.S. Pat. No. ______). The sorbents are structurally stable, low cost, scale-able, and reusable.

Polyamine/epoxysilane/silica sorbents were more stable to amine leaching and likely amine rearrangement than sorbents without ES. The introduction of a thin metal coating increased the uptake of difficult to capture metal oxyanions of Cr, As, and Se.

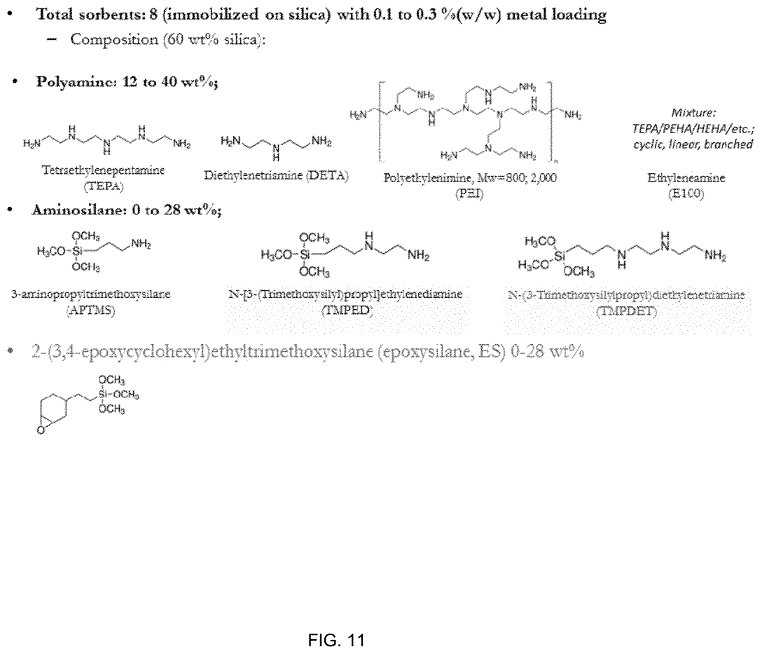

Covalently stabilized PEI800-epoxysilane-SiO2, with covalent metal attachment doubled the uptake of As and Se, when compared to the non-loaded counterpart. FIG. 11 depicts constituents for synthesizing the metal-loaded polyamine compositions for immobilization on silica.

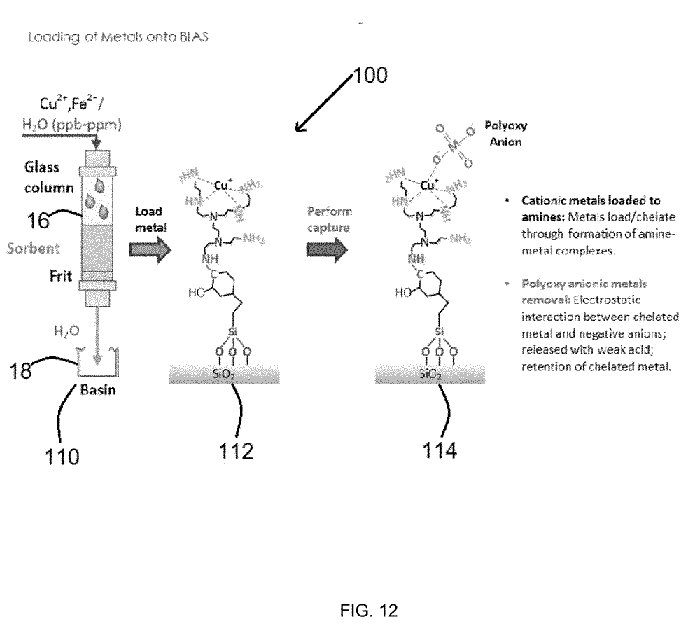

FIG. 12 depicts a schematic illustrating a method 100 for the synthesis of a metal loaded sorbent in accordance with one embodiment. Method 100 includes the glass column 16 and basin 18 of FIG. 1. Method 100 includes metals loaded on the support (the solid silica support for example) 112. In at least one embodiment cationic metals are loaded to the amines, where the metals load/chelate through the formation of amine-metal complexes. Method 100 further includes performing capture 114 where polyoxy anionic metals are removed via electrostatic interaction between chelated metal and negative anions; are release using weak acids and chelated metal is retained.

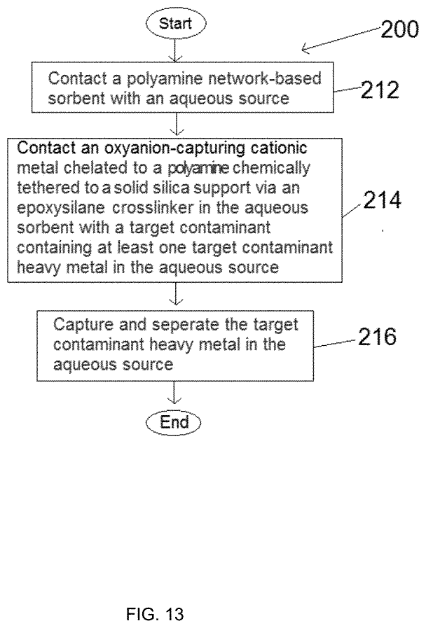

FIG. 13 depicts a flowchart illustrating a method, generally designated 200, for separating a target contaminant from an aqueous source, more specifically for separating a target contaminant containing at least one target contaminant heavy metal from an aqueous source. One or more embodiments of method 200 includes contacting a polyamine network-based sorbent with the aqueous source 212. Method 200 further includes contacting a polyamine network-based sorbent comprising an oxyanion-capturing cationic metal chelated to a polyamine chemically tethered to a solid silica support via an epoxysilane crosslinker with the aqueous source 214 and capturing and separating the target contaminant heavy metal from the aqueous source 216.

In at least one embodiment, capturing and separating the target contaminant heavy metal 216 may include chelating an oxyanion-capturing cationic metal to assist in the capturing and separating of the target contaminant heavy metal. Chelating the oxyanion-capturing cationic metal to assist in the capturing and separating the target contaminant heavy metal may include preventing at least the target contaminant heavy metal from leaching back into the aqueous source. In one or more embodiments of method 200, the polyamine network-based sorbent may include the oxyanion-capturing cationic metal chelated to a polyamine chemically tethered to a solid silica support via an epoxysilane crosslinker.

In one or more embodiments of method 200, the crosslinker may include an epoxysilane linker, a tri-epoxide linker, or an acrylamide-based linker. Alternatively, the crosslinker may include 2-(3,4-epoxycyclohexyl)ethyltrimethoxysilane (ECTMS), bisphenyl A diglycidyl ether, N-N-diglycidyl-4-glycidyloxyanaline (E3), or 4,4′-methylenebis(N,N-diglycidylaniline), acrylamide, N,N′-methylene bisacrylamide, or mixtures thereof.

In one or more embodiments depicted by the method of FIG. 13, the support may include a solid silica support which may encompass a SiO₂, an activated carbon, a biochar, an AlO₂, composites thereof or physical mixtures thereof. In one or more embodiments, the chelated oxyanion-capturing cationic metal may encompass Fe, Cu, Al, and/or Mo. Further, the polyamine network may include polyethylenimine (molecular weight 400 to 1,000,000), ethylenediamine, diethylenetriamine, triethylenetetramine, tetraethylenepentamine, pentaethylenehexamine, hexaethyleneheptamine, 1,3-cyclohexanebis(methylamine), 4,4′-methylenebis(cyclohexylamine), 3,3′-methylenedianiline, o-phenylenediamine, m-phenylenediamine, p-phenylenediamine, tris(2-aminoethyl)amine, p-xylylenediamine, 4-chloro-o-phenylenediamine, N,N′-dimethyl-1,3-propanediamine, N,N′-Diphenyl-p-phenylenediamine, N,N′-diisopropyl-1,3-propanediamine, polyvinyl amine, and/or poly(allylamine).

Exemplary target contaminant heavy metals may include alkali metals, alkaline earth metals, lanthanoids (rare earth elements), actinoids, transition metals, post transition metals, reactive non-metals, polyatomic oxoanionic or cationic toxic heavy metals. Heavy metals may also include Cr, As, Hg, Sr, Se, and Re. Additionally embodiments may include non-heavy metal anions such as sulfate, sulfite, nitrate, nitrite, phosphate, and/or phosphite. Alternatively, it may include one or more heavy metal radioactive isotope.

Exemplary uses of the invention primarily include any flowing or stagnant aqueous system with heavy metal contamination, which includes industrial effluent such as coal associated waste streams, acid mine drainage effluent streams and hydraulic fracturing water, ponds, rivers, lakes, seawater, and/or groundwater

Alternative uses of the invention include the absorption of diverse types of heavy metals or the incorporation of different metals, in a variety of oxidation states into the sorbent formula for use in cleanup strategies from the previously mentioned aqueous sources.

Additional uses include immobilized metals for catalytic use as a heterogeneous catalyst in organic synthesis and drug design for coupling reactions, polymerization reactions, oxidation/reduction reactions, hydrogenation reactions, addition/elimination reactions and substitution reactions.

It is contemplated that the polyamine network-based sorbent used in separating a target contaminant from an aqueous source as provided in FIG. 13 may include chemically tethering a polyamine to a solid silica support using an epoxysilane crosslinker. The oxyanion-capturing cationic metal may be chelated to the polyamine.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A method of separating a target contaminant from an aqueous source comprising:
contacting a polyamine network-based sorbent with the aqueous source; and
capturing and separating the target contaminant from the aqueous source.

2. The method of claim 1 wherein the target contaminant comprises at least one target contaminant heavy metal.

3. The method of claim 2 wherein the capturing and separating the target contaminant heavy metal comprises chelating an oxyanion-capturing cationic metal to assist in the capturing and separating of the target contaminant heavy metal.

4. The method of claim 3 wherein chelating the oxyanion-capturing cationic metal to assist in the capturing and separating the target contaminant heavy metal comprises preventing at least the target contaminant heavy metal from leaching back into the aqueous source.

5. The method of claim 1 wherein the polyamine network-based sorbent comprises an oxyanion-capturing cationic metal chelated to a polyamine chemically tethered to a solid silica support via an epoxysilane crosslinker.

6. The method of claim 5 wherein the crosslinker comprises an epoxysilane linker, a tri-epoxide linker, or an acrylamide-based linker.

7. The method of claim 5 wherein the crosslinker comprises 2-(3,4-epoxycyclohexyl)ethyltrimethoxysilane (ECTMS), bisphenyl A diglycidyl ether, N-N-diglycidyl-4-glycidyloxyanaline (E3), or 4,4′-methylenebis(N,N-diglycidylaniline), acrylamide, N,N′-methylene bisacrylamide, or mixtures thereof.

8. The method of claim 5 wherein the solid silica support comprises an SiO₂, activated carbon, a biochar, an AlO₂, composites thereof or physical mixtures thereof.

9. The method of claim 5 wherein the chelated oxyanion-capturing cationic metal comprises Fe, Cu, Al, or Mo.

10. The method of claim 1 wherein the polyamine network comprises polyethylenimine (molecular weight 400 to 1,000,000), ethylenediamine, diethylenetriamine, triethylenetetramine, tetraethylenepentamine, pentaethylenehexamine, hexaethyleneheptamine, poly(propyleneimine), 1,3-cyclohexanebis(methylamine), 4,4′-methylenebis(cyclohexylamine), 3,3′-methylenedianiline, o-phenylenediamine, m-phenylenediamine, p-phenylenediamine, tris(2-aminoethyl)amine, p-xylylenediamine, 4-chloro-o-phenylenediamine, N,N′-dimethyl-1,3-propanediamine, N,N′-Diphenyl-p-phenylenediamine, N,N′-diisopropyl-1,3-propanediamine, polyvinyl amine, or poly(allylamine).

11. The method of claim 2 wherein the target contaminant heavy metal comprises alkali metals, alkaline earth metals, lanthanoids (rare earth elements), actinoids, transition metals, post transition metals, or reactive non-metals.

12. The method of claim 2 wherein the target contaminant heavy metal comprises polyatomic oxoanionic or cationic toxic heavy metals.

13. The method of claim 2 wherein the target contaminant heavy metal includes a heavy metal radioactive isotope.

14. The method of claim 1 wherein the aqueous source comprises coal associated waste streams, acid mine drainage effluent streams or hydraulic fracturing water.

15. The method of claim 1 wherein the heavy metals comprise Cr, As, Hg, Sr, Se, and Re.

16. The method of claim 1 wherein further comprising non-heavy metal anions comprising sulfate, sulfite, nitrate, nitrite, phosphate, or phosphite.

17. The method of claim 1 wherein the heavy metal comprises polyatomic, oxoanionic, and cationic toxic heavy metals.

18. The method of claim 1 wherein the heavy metal comprises a heavy metal radioactive isotope.

19. A method of separating a target contaminant containing at least one target contaminant heavy metal from an aqueous source comprising:
contacting a polyamine network-based sorbent comprising an oxyanion-capturing cationic metal chelated to a polyamine chemically tethered to a solid silica support via an epoxysilane crosslinker with the aqueous source; and
capturing and separating the target contaminant heavy metal from the aqueous source.

20. A method of forming a polyamine network-based sorbent used in separating a target contaminant from an aqueous source comprising:
chemically tethering a polyamine to a solid silica support using an epoxysilane crosslinker; and
chelating an oxyanion-capturing cationic metal to the polyamine.
